(19) United States
(12) Patent Application Publication
(10) Pub. No.: US 2007/0009805 A1
(43) Pub. Date: Jan. 11, 2007

(54) Polymer electrolyte

(76) Inventors: Peter V. Wright, Sheffield (GB); Jianguo Liu, Sheffield (GB)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 10/556,671

(22) PCT Filed: May 11, 2004
(86) PCT No.: PCT/GB04/02024

§ 371 Date: Nov. 14, 2005

(30) Foreign Application Priority Data
May 13, 2003 (GB) 03109527
May 13, 2003 (GB) 03109535

(51) Int. Cl. H01M 10/40

(52) U.S. Cl. 429/309; 429/317

(57) ABSTRACT

A polymer based electrolyte complex being configured to provide ion transport, said complex comprising: a plurality of ion conducting polymers, each polymer of said plurality of polymers comprising an amphiphilic repeating unit, said polymers being arranged as a lattice of ionophobic repeating unit regions and ionophilic repeating unit channels, said channels being configured to provide ion transport; a first ionic bridge polymer positioned substantially between said lattice, said ionic bridge polymer being configured to allow ion transport between said ionophilic repeating unit channels of said lattice; said complex further comprising and being characterised by: a second ionic bridge polymer positioned substantially between said lattice, said second ionic bridge polymer being configured to allow ion transport between said ionophilic repeating unit channels of said lattice.

### FIELD OF THE INVENTION

The present invention relates to polymers and in particular, although not exclusively, to organised polymer electrolyte complexes configured for ion transport.

### BACKGROUND TO THE INVENTION

Within the field of polymer electrolytes four distinct types of material, reflecting four different mechanistic approaches to ion mobility, have been recognised. i) The translation of lithium salts through liquid solvents in gels or ‘hybrid’ materials of various kinds. ii) Solvent-free, salt—polymer complexed systems in which the ion motion is coupled to the micro-brownian motion of segments of the polymer chains above the glass or melting transitions of the system. iii) ‘Single-ion’ systems, in which the lithium ion moves by a hopping process between anionic sites fixed to the polymer chain, or systems with reduced mobility of anions (solvent—containing or solvent-free). iv) Solvent-free, salt-polymer complexed systems in which ion mobility is uncoupled to the motions of polymer chain segments.

The drive towards solvent-free polymer electrolytes stems from the hazards associated with the highly reactive lithium (currently used within batteries) in contact with low-molecular weight solvents. This is especially apparent for heavy-duty battery applications in which operation at elevated temperatures might be anticipated. Accordingly a very real risk of fire and explosion is to be associated with heavy-duty applications of such conventional lithium—organic solvent batteries.

Conventionally, solvent-free polymer electrolytes have been largely based upon complexes of lithium salts in amorphous forms of polyethylene oxide (PEO), this polymer dissolves lithium salts to give semi-crystalline or fully amorphous complex phases where ion migration through the amorphous phases gives rise to significant conductivity; M. B. Armand, in J. R. MacCallum, C. A. Vincent (Eds) Polymer Electrolyte Reviews 1, Elsevier, London, 1987, Chapter 1; G. Cameron and M. D. Ingram, in J. R. MacCallum, C. A. Vincent (Eds) Polymer Electrolyte Reviews 2, Elsevier, London, 1989, Chapter 5.; F. M. Gray, Polymer Electrolytes, the Royal Society of Chemistry, Cambridge, UK, 1997, Chapter 1. Ion mobilities in these systems are free-volume dependent and are essentially coupled to the segmental mobilities of the rubbery polymer, the conductivity, a, generally following a strong temperature dependence. Whilst conductivities at temperatures above ca. 80° C. approach 10⁻³ S cm⁻¹, which is adequate for successful operation of lithium batteries at such temperatures, a variety of strategies have thus far failed to bring about conductivities greater than ca. 10⁻⁴ S cm⁻¹ at ambient temperatures (25° C.).

In particular, the application of amorphous forms of PEO in ambient temperature batteries, requiring conductivities of ca. 10⁻³ S cm⁻¹ is prohibited due to their low ambient conductivity. Other amorphous systems giving conductivities between 10⁻⁴ to 10⁻⁵ S cm⁻¹ have been proposed C. A. Angell. C. Liu and E Sanchez. Nature. 1993. 362. 137.; F. Croce. C. Appetecchi. L. Persi and B. Scrosati. Nature. 1998.394. 456.

In an attempt to address the low ambient temperature conductivities associated with PEO based electrolytes, various extended helical crystalline structures of PEO-alkyl salt complexes have been proposed forming organised low-dimensional polymer complexes, Y. Chatani and S. Okamura. Polymer. 1987 28. 1815.; P. Lightfoot. M. A. Mehta and P. G. Bruce. Science. 1993. 262. 883.; Y. G. Andreev. P. Lightfoot. And P. g. Bruce. J. Appl. Crystallogr., 1997. 18. 294; F. B. Dias. J. P. Voss. S. V. Batty. P. V. Wright and G. Ungar. Macromol. Rapid Common., 1994. 15. 961.; F. B. Dias. S. V. Batty. G. Ungar. J. P. Voss. And P. V. Wright. J. Chem. Soc., Faraday Trans., 1996. 92. 2599.; P. V. Wright. Y. Zheng. D Bhatt. T. Richardson and G. Ungar. Polym. Int., 1998. 47. 34.; Y. Zheng. P. V. Wright and G. Ungar. Electrochim. Acta. 2000., 45. 1161.; Y. Zheng. A Gibaud. N. cowlam. T. H. Richardson. G. Ungar and P. V. Wright. J Mater. Chem., 2000. 10. 69, Yungui Zheng, Fusiong Chia, Goran Ungar and Peter. V. Wright, Chem. Commun., 2000, 1459-1460.

Of these most recent solvent-free low-dimensional polymer electrolyte blends, a helical polymer backbone provides support for alkyl side-chains which interdigitate in a hexagonal lattice layer between the polyether helical backbones. Cations are encapsulated within the helices, one per repeat unit/helical turn, where the anions lie in the interhelical spaces. These three-component systems incorporate a long chain n-alkyl or alkane molecule, the inclusion of which provides increased conductivities resulting from highly-organised lamellar textures where the long chain n-alkyl or alkane molecule is embedded between lamellar layers.

However, such solvent-free polymer electrolyte complexes still exhibit temperature dependent conductivities in addition to unsatisfactory conductivity levels at ambient temperature.

What is required therefore is a solvent-free electrolyte exhibiting reduced temperature dependent conductivities and/or increased conductivity at ambient temperature operating conditions.

### SUMMARY OF THE INVENTION

The inventors provide improved solvent-free polymer electrolytes capable of conductivities over the range 10⁻⁴ S cm⁻¹ 10⁻² S cm⁻¹ at ambient temperatures. The new amphiphilic polymer electrolytes may be divided into two classes of materials, i) hydrocarbon side-chain polyether—Li salt complexes and ii) main-chain alkylene polyether—Li salt block polymers.

Under the first class of material a four-component low-dimensional polymer electrolyte complex may be provided involving blends of an amphiphilic polymer, a first ionic bridge polymer, in conjunction with a metal salt, in particular Li salts (e.g. LiClO₄, LiBF₄, Li(CF₃SO₂)₂N and LiCF₃SO₃).

Metal ion transport is provided through the polymer electrolyte system via ionophilic polymer regions (forming part of amphiphilic polymer repeating units). According to specific implementations of the present invention the polymer lattice is provided as a result of organisation of the ion conducting polymer into lamellar or micellar morphologies. Polymers in general are not entropically disposed to blend at the molecular level but a third component, e.g. a metal salt (lithium salt) has been found to have influence on the blending/de-blending and hence the morphology and ionic conduction of the electrolyte: metal salt system lonophilic regions or channels are provided within the lattice structure allowing transport of metal cations between anode and cathode, where the electrolyte forms part of a galvanic cell or battery, in particular a secondary battery being rechargeable.

Interdispersed between the ion conducting amphiphilic polymer regions is at least one ionic bridge polymer, the inclusion of which has been found to enhance conductivity levels with reduced temperature dependent conductivity characteristics. The at least one ionic bridge polymer positioned between the lamellar or micellular organised ion conducting polymer may be regarded as a “glue” serving to fill the region between lamellar layers or micellar aggregates. The effect of the ionic bridge polymer(s) may be particularly apparent when shrinkage occurs within the ion conducting polymer lattice, ion transport across the electrolyte being maintained via the interdispersed ionic bridge polymer(s).

An additional advantage associated with the ionic bridge polymer(s) is the facilitation of electrolyte blending and de-blending resulting from interaction/cooperation between ionophilic/ionophobic regions of the ionic bridge polymer(s) and ionophilic/ionophobic regions of the ion conducting polymer.

In particular, where the ion conducting polymer comprises ionophobic hydrocarbon side-chains ion mobility is extended due to incorporation within the polymer electrolyte of the ionic bridge polymer(s). For example, on heating a blend of the ion conducting polymer: ionic bridge polymer(s): metal salt electrolyte complex, a de-blending process occurs from which the ion conducting polymer: metal salt complex separates into stable, highly-organised lamellar or micellar textures. The amphiphilic repeating units condensed together to create ion conducting regions or channels in addition to interdigitation between ionophobic side-chains. Typically, at low operating temperatures these side-chains crystallise resulting in reduced conductivity (ion mobility) due to lattice shrinkage and/or restricted ionophilic ion conducting region flexibility. The resultant decrease in conductivity, according to the present invention, is offset due to incorporation of the ionic bridge polymer(s) functioning as a “glue” or ionic bridge between ionophilic ion transporting regions.

According to the second class of material a main-chain alkylene: polyether: metal salt electrolyte complex is provided where the amphiphilic ion conducting polymer self organises into ionophilic and ionophobic regions, in turn providing metal ion mobility pathways to achieve the required conductivity.

Similarly, such systems may incorporate the ionic bridge polymer(s) interdispersed within the ion conducting polymer lattice so as to provide an intermediate ion conducting medium between the ionophilic ion conducting units/channels of the polymer lattice. Enhanced ion conductivity and a reduced temperature dependent conductivity may be realised through such systems.

According to a first aspect of the present invention, there is provided a polymer based electrolyte complex being configured to provide ion transport, said complex comprises: a plurality of ion conducting polymers, each polymer of said plurality of polymers comprising an amphiphilic repeating unit, said polymers being arranged as a lattice of ionophobic repeating unit regions and ionophilic repeating unit channels, said channels being configured to provide ion transport; a first ionic bridge polymer positioned substantially between said lattice, said ionic bridge polymer being configured to allow ion transport between said ionophilic repeating unit channels of said lattice; said complex further comprises and being characterised by: a second ionic bridge polymer positioned substantially between said lattice, said second ionic bridge polymer being configured to allow ion transport between said ionophilic repeating unit channels of said lattice.

Preferably, said lattice of ion conducting polymers comprises a lamellar morphology.

Preferably, said lattice of ion conducting polymers comprises a micellar morphology.

Preferably, each polymer of said plurality of ion conducting polymers is represented by general formula (1):

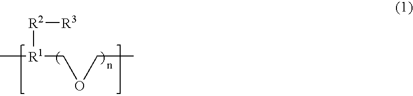

where R¹ is alkylene or a benzene nucleus; R² is oxygen, nitrogen, alkylene, phenylene or CH₂; R³ is alkyl, phenyl or alkyl-phenyl and 8≧n≧2, preferably n is 5.

Preferably, R¹ is a benzene nucleus, R² is oxygen and R³ is a substantially straight chain hydrocarbon preferably —(CH₂)ₘ—H where 30≧m≧5, more preferably m is 12, 16 or 18.

Preferably, R¹ is CH, R² is oxygen and R³ is a substantially straight chain hydrocarbon preferably —(CH₂)ₘ—H where 30≧m≧5, more preferably m is 12, 16 or 18.

Preferably, each polymer of said plurality of ion conducting polymers is represented by general formula (2):

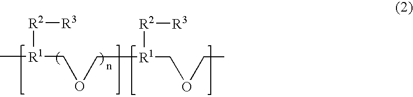

where R¹ is alkylene or a benzene nucleus; R² is oxygen, nitrogen, alkylene, phenylene or CH₂; R³ is alkyl or phenyl, a substantially straight chain hydrocarbon preferably —(CH₂)ₘ—H where 30≧m≧5, more preferably m is 12, 16 or 18 and 8≧n≧2 preferably n is 5.

Preferably, the electrolyte complex comprises a combination of said straight chain hydrocarbon where m is 12 and 18.

Preferably, the electrolyte complex comprises a 50:50 mixture of C₁₂H₂₅ and C₁₈H₃₇ substantially straight chain hydrocarbon.

Preferably, each polymer of said plurality of ion conducting polymers is represented by the general formula (3):

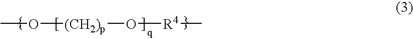

where R⁴ is alkylene or phenylene, a substantially straight chain hydrocarbon preferably (CH₂)ₘ where 30≧m≧5, more preferably m is 12, 16 or 18; 5≧p≧1, preferably p is 2; 6≧q≧2, preferablyq is4or5.

Preferably, said first ionic bridge polymer is represented by the general formula (4): [symbol]
O-(A-O-)ₓ-B [symbol] (4)
where A is alkylene or phenylene; B is alkylene, phenylene, alkylene ether, phenylene ether, alkylene-phenylene ether, alkoxy-phenylene ether or alkyl-phenylene ether;, 40≧x≧20.

According to specific implementations of compound (4) the alkoxy or alkyl component may comprise —(CH₂)ₘ—H where 30≧m≧5, more preferably m is 12, 16 or 18.

Preferably, A is (CH₂)₄; B is a substantially straight chain hydrocarbon preferably (CH₂)ₘ where 30≧m≧5, more preferably m is 12, 16 or 18, or B is —O—C₆H₄—O—(C H₂)₁₂—O—C₆H₄—O—.

Preferably, said second ionic bridge polymer is represented by the general formula (5):

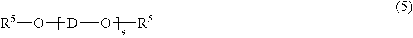

where D is alkylene or phenylene, preferably (CH₂)ᵣ, where 5≧r≧2, preferably r is 4; R⁵ is alkyl, phenyl, a straight chain or branched aliphatic hydrocarbon preferably C₁₈H₃₇; 40≧s≧20.

According to a specific implementation of the present invention the second ionic bridge polymer may be bonded to at least one end of the ion conducting polymer. For example, R⁵ of general formula (5) may be replaced with any one of repeating units, being represented by general formula (1), (2) or (3). Accordingly, the second ionic bridge polymer is maintained at the interface between the amphiphilic ion coordinating regions and the interdispersed first ionic bridge polymer.

Accordingly enhanced conductivity of the polymer electrolyte may be associated with the ionic bridge-ion conducting polymer hybrid species due to the even distribution of the second ionic bridge polymer at the interface with the first ionic bridge polymer. The bonding of the second ionic bridge polymer to the end units of the ion coordinating regions or channels may avoid a requirement to incorporate the separate and mobile second ionic bridge polymer in combination with the first ionic bridge polymer.

A possible synthetic route for the preparation of the above second ionic bridge polymer—ion conducting polymer hybrid species involves the preparation of the ion conducting polymer followed by introduction of the second ionic bridge polymer within a suitable solvent medium. The second ionic bridge polymer is therefore “tagged” onto the end of the ion conducting polymer following the polymerisation of the ion conducting polymer.

According to a second aspect of the present invention, there is provided a polymer based electrolyte complex comprising: an ion conducting polymer being represented by the general formula (1):

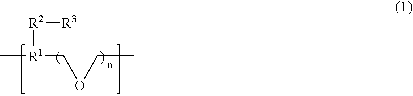

where R¹ is alkylene or a benzene nucleus; R² is oxygen, nitrogen, alkylene, phenylene or CH₂; R³ is alkyl, phenyl or alkyl-phenyl, a substantially straight chain hydrocarbon preferably —(CH₂)ₘ—H where 30≧m≧5, more preferably m is 12, 16 or 18 and 8≧n≧2, preferably n is 5;

a second ionic bridge polymer being represented by general formula (5):

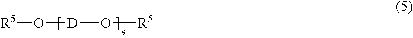

where D is alkylene or phenylene, preferably (CH₂)ᵣ, where 5≧r≧2, preferably r is 4; R⁵ is alkyl, phenyl, a straight chain or branched aliphatic hydrocarbon preferably C₁₈H₃₇; 40≧s≧20.

Preferably, the electrolyte complex further comprises a first ionic bridge polymer being represented by general formula (4): [symbol]
O-(A-O-)ₓ-B [symbol] (4)

where A is alkylene or phenylene; B is alkylene, phenylene, alkylene ether, phenylene ether, alkylene-phenylene ether, alkoxy-phenylene ether or alkyl-phenylene ether;, preferably B is —O—C₆H₄—O—(CH₂)₁₂—O—C₆H₄—O—; 40≧x≧20.

Preferably, R¹ is a benzene nucleus or CH; R² is oxygen; A is (CH₂)₄ and B is a substantially straight chain hydrocarbon preferably (CH₂)ₘ where 30≧m≧5, more preferably m is 12, 16 or 18.

According to a third aspect of the present invention, there is provided a polymer based electrolyte complex comprising: an ion conducting copolymer being represented by the general formula (2):

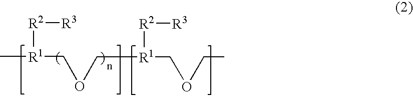

where R¹ is alkylene or a benzene nucleus; R² is oxygen, nitrogen, alkylene, phenylene or CH₂; R³ is alkyl or phenyl, a substantially straight chain hydrocarbon preferably —(CH₂)ₘ—H where 30≧m≧5, more preferably m is 12, 16 or 18 and 8≧n≧2 preferably n is 5; and

a second ionic bridge polymer being represented by general formula (5):

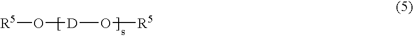

where D is alkylene or phenylene, preferably (CH₂)ᵣ, where 5≧r≧2, preferably r is 4; R⁵ is alkyl, phenyl, a straight chain or branched aliphatic hydrocarbon preferably C₁₈H₃₇; 40≧s≧20.

Preferably, the electrolyte complex further comprises a first ionic bridge polymer being represented by general formula (4): [symbol]
O-(A-O-)ₓ-B [symbol] (4)

where A is alkylene or phenylene; B is alkylene, phenylene, alkylene ether, phenylene ether, alkylene-phenylene ether, alkoxy-phenylene ether or alkyl-phenylene ether;, preferably B is —O—C₆H₄—O—(CH₂)₁₂—O—C₆H₄—O—; 40≧x≧20.

Preferably, R¹ is a benzene nucleus or CH; R² is oxygen; A is (CH₂)₄; B is a substantially straight chain hydrocarbon preferably (CH₂)ₘ where 30≧m≧5, more preferably m is 12, 16 or 18.

Preferably, said electrolyte complex comprises a plurality of ion conducting polymers arranged in a lamellar morphology.

Preferably, said electrolyte complex comprises a plurality of ion conducting polymers arranged in a micellar morphology.

According to a fourth aspect of the present invention, there is provided a polymer electrolyte being configured to provide ion transport, said electrolyte comprising:

an ion conducting polymer comprising an amphiphilic repeating unit, said ion conducting polymer being represented by general formula (3):

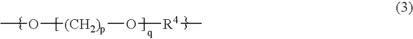

where R⁴ is alkylene or phenylene, a substantially straight chain hydrocarbon preferably (CH₂)ₘ where 30≧m≧5, more preferably m is 12, 16 or 18; 5≧p≧1, preferably p is 2; 6≧q≧2, preferably q is 4 or 5;

wherein said ion conducting polymer is arranged as a lattice of ionophobic repeating unit regions and ionophilic repeating unit regions, said ionophilic repeating unit regions being configured to provide ion transport.

Preferably, the polymer electrolyte further comprises:

a first ionic bridge polymer being positioned substantially between said lattice of said ion conducting polymer, said first ionic bridge polymer being configured to allow ion transport between said ionophilic repeating unit regions of said lattice.

Preferably, said first ionic bridge polymer is represented by the general formula (4): [symbol]
O-(A-O-)ₓ-B [symbol] (4)

where A is alkylene or phenylene; B is alkylene, phenylene, alkylene ether, phenylene ether, alkylene-phenylene ether, alkoxy-phenylene ether or alkyl-phenylene ether;, preferably B is —O—C₆H₄—O—(CH₂)₁₂—O'C₆H₄—O—; 40≧x≧20.

Preferably, the polymer electrolyte further comprises:

a second ionic bridge polymer being positioned substantially between said lattice of said ion conducting polymer, said first ionic bridge polymer being configured to allow ion transport between said ionophilic repeating unit regions of said lattice.

Preferably, said second ionic bridge polymer is represented by the general formula (5): 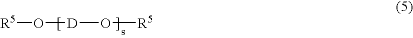
where D is alkylene or phenylene, preferably (CH₂)ᵣ, where 5≧r≧2, preferably r is 4; R⁵ is alkyl, phenyl, a straight chain or branched aliphatic hydrocarbon preferably C₁₈H₃₇; 40≧s≧20.

Preferably, A is (CH₂)₄; B is a substantially straight chain hydrocarbon preferably (CH₂)ₘ where 30≧m≧5, more preferably m is 12, 16 or 18.

Preferably, said ion conducting polymer comprises a lamellar morphology.

Preferably, said ion conducting polymer comprises a micellar morphology.

According to a fifth aspect of the present invention, there is provided a polymer based electrolyte complex being configured to provide ion transport, said complex comprising: an ion conducting polymer comprising an amphiphilic repeating unit, said ion conducting polymer being arranged as a lattice of ionophilic repeating unit regions and ionophobic repeating unit regions, said ionophilic repeating unit regions being configured to provide ion transport; and an ionic bridge polymer being positioned substantially between said lattice, said ionic bridge polymer being configured to allow ion transport between said ion conducting polymers, said ionic bridge polymer being represented by general formula (5):

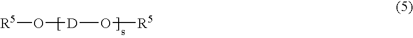

where D is alkylene or phenylene, preferably (CH₂)ᵣ, where 5≧r≧2, preferably r is 4; R⁵ is alkyl, phenyl, a straight chain or branched aliphatic hydrocarbon preferably C₁₈H₃₇; 40≧s≧20.

Preferably, said ion conducting polymer is represented by general formula (1)

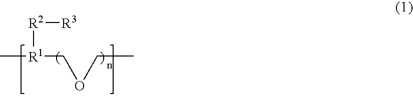

where R¹ is alkylene or a benzene nucleus; R² is oxygen, nitrogen, alkylene, phenylene or CH₂; R³ is alkyl, phenyl or alkyl-phenyl and 8≧n≧2, preferably n is 5.

Preferably, said ion conducting polymer is represented by general formula (2):

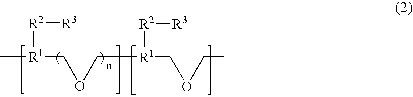

where R¹ is alkylene or a benzene nucleus; R² is oxygen, nitrogen, alkylene, phenylene or CH₂; R³ is alkyl or phenylene, a substantially straight chain hydrocarbon preferably —(CH₂)ₘ—H where 30≧m≧5, more preferably m is 12, 16 or 18 and 8≧n≧2 preferably n is 5.

Preferably, said ion conducting polymer is represented by general formula (3):

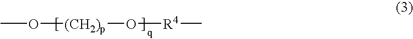

where R⁴ is alkylene or phenylene, a substantially straight chain hydrocarbon preferably (CH₂)ₘ where 30≧m≧5, more preferably m is 12, 16 or 18; 5≧p≧1, preferably p is 2; 6 2≧q≧2, preferably q is 4 or 5.

According to a specific aspect of the present invention a battery is provided comprising the polymer electrolyte/electrolyte complex according to the present invention herein. Particularly, the battery is configured to provide ion transport, in particular lithium ion transference. According to the specific implementation of the present invention, the battery is a solvent-free battery wherein electrolyte-decoupled ion transport occurs via ionophilic repeating unit channels between a cathode and an anode.

Preferably, the battery, comprising an electrolyte, comprises a lithium salt being represented by general formula (6):
LiX (6)

where X is ClO₄⁻, BF₄⁻, CF₃SO₃⁻ and/or (CF₃SO₂)N⁻;

wherein said electrolyte is operable with conductivities in the range 10⁻⁴ S cm⁻¹ to 10⁻² S cm⁻¹ at ambient temperature.

According to a sixth aspect of the present invention, there is provided a process for the preparation of a polymer being represented by general formula (3): 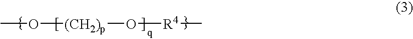
where R⁴ is alkylene or phenylene, a substantially straight chain hydrocarbon preferably (CH₂)ₘ where 30≧m≧5, more preferably m is 12, 16 or 18; 5≧p≧1, preferably p is 2; 6≧q≧2, preferably q is 4 or 5.1

comprising the steps of:

(a) reacting a compound of general formula (7):

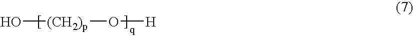

with Z—R⁴—Z, where Z is a halogen, preferably Br. According to a seventh aspect of the present invention, there is provided a process for the preparation of a polymer being represented by general formula (5)

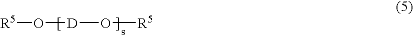

where D is alkylene or phenylene, preferably (CH₂)ᵣ, where 5≧r≧2, preferably r is 4; R⁵ is alkyl or phenyl, preferably C₁₈H₃₇; 40≧s≧20.

comprising the steps of:

(a) reacting a compound being represented by general formula (8): 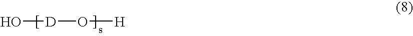
with R⁵—Z, where Z is a halogen, preferably Br.

According to an eighth aspect of the present invention, there is provided a process for the preparation of a polymer based electrolyte complex comprising the steps of:

(a) forming an ion conducting polymeric material having repeating units being represented by general formula (1):

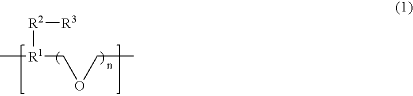

where R¹ is alkylene or a benzene nucleus; R² is oxygen, nitrogen, alkylene, phenylene or CH₂; R³ is alkyl, phenyl, a substantially straight chain hydrocarbon preferably —(CH₂)ₘ—H where 30≧m≧5, more preferably m is 12, 16 or 18 and 8≧n≧2, preferably n is 5;

(b) blending polymer (1) with a second ionic bridge polymer, said second ionic bridge polymer being represented by general formula (5):

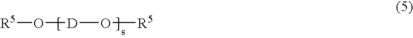

where D is alkylene or phenylene, preferably (CH₂)ᵣ, where 5≧r≧2, preferably r is 4; R⁵ is alkyl, phenyl, a straight chain or branched aliphatic hydrocarbon preferably C₁₈H₃₇; 40≧s≧20; and

(c) de-blending the polymeric blend of polymer (1) and (5) by heating said polymeric blend above a transition temperature.

Preferably, the process further comprises the steps of:

(d) prior to said heating step (c), blending polymer (1) and polymer (5) with a first ionic bridge polymer, said first ionic bridge polymer being represented by general formula (4): [symbol]
O-(A-O-)ₓ-B [symbol] (4)

where A is alkylene or phenylene; B is alkylene, phenylene, alkylene ether, phenylene ether, alkylene-phenylene ether, alkoxy-phenylene ether or alkyl-phenylene ether;, preferably B is —O—C₆H₄—O—(CH₂)₁₂—O—C₆H₄—O—; 40≧x≧20.

Preferably, said transition temperature is above a melting or glass transition temperature of polymer (1).

Preferably, R¹ is a benzene nucleus or CH; R² is oxygen; A is (CH₂)₄; B is a substantially straight chain hydrocarbon preferably (CH₂)ₘ where 30≧m≧5, more preferably m is 12, 16 or 18.

According to a ninth aspect of the present invention, there is provided a process for the preparation of a polymer based electrolyte complex comprising the steps of:

(a) forming an ion conducting polymeric material having repeating units being represented by general formula (2):

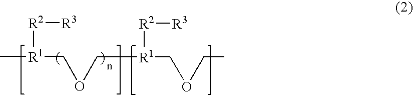

where R¹ is alkylene or a benzene nucleus; R² is oxygen, nitrogen, alkylene, phenylene or CH₂; R³ is alkyl or phenyl, a substantially straight chain hydrocarbon preferably —(CH₂)ₘ—H where 30≧m≧5, more preferably m is 12, 16 or 18 and 8≧n≧2preferably n is 5;

(b) blending polymer (2) with a second ionic bridge polymer, said second ionic bridge polymer being represented by general formula (5):

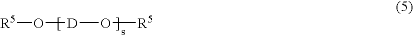

where D is alkylene or phenylene, preferably (CH₂)ᵣ, where 5≧r≧2, preferably r is 4; R⁵ is alkyl, phenyl, a straight chain or branched aliphatic hydrocarbon preferably C₁₈H₃₇; 40≧s≧20; and

(c) de-blending the polymeric blend of polymer (2) and (5) by heating said polymeric blend above a transition temperature.

Preferably, the process further comprises the step of:

(d) prior to said heating step (c) blending polymer (2) and polymer (5) with a first ionic bridge polymer, said first ionic bridge polymer being represented by general formula(4): [symbol]
O-(A-O-)ₓ-B [symbol] (4)

where A is alkylene or phenylene; B is alkylene, phenylene, alkylene ether, phenylene ether, alkylene-phenylene ether, alkoxy-phenylene ether or alkyl-phenylene ether;, preferably B is —O—C₆H₄—O—(CH₂)₁₂—O—C₆H₄—O—; 40≧x≧20.

Preferably, said transition temperature is above a melting or glass transition temperature of polymer (2).

Preferably, R¹ is a benzene nucleus or CH; R² is oxygen; A is (CH₂)₄; B is a substantially straight chain hydrocarbon preferably (CH₂)ₘ where 30≧m≧5, more preferably m is 12, 16 or 18.

According to a tenth aspect of the present invention, there is provided a process for the preparation of a polymer based electrolyte complex comprising the steps of:

(a) forming an ion conducting polymeric material having repeating units being represented by general formula (3):

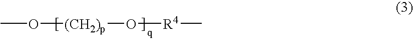

where R⁴ is alkylene or phenylene, a substantially straight chain hydrocarbon preferably (CH₂)ₘ where 30≧m≧5, more preferably m is 12, 16 or 18; 5≧p≧1, preferably p is 2; 6≧q≧2, preferably q is 4 or 5;

(b) blending polymer (3) with a second ionic bridge polymer, said second ionic bridge polymer being represented by general formula (5):

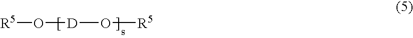

where D is alkylene or phenylene, preferably (CH₂)ᵣ, where 5≧r≧2, preferably r is 4; R⁵ is alkyl, phenyl, a straight chain or branched aliphatic hydrocarbon preferably C₁₈H₃₇; 40≧s≧20;

(c) de-blending the polymeric blend of polymer (3) and (5) by heating said polymeric blend above a transition temperature.

Preferably, the process further comprises the step of:

(d) prior to said heating step (c), blending polymer (3) and polymer (5) with a first ionic bridge polymer, said first ionic bridge polymer being represented by general formula (4): [symbol]
O-(A-O-)ₓ-B [symbol] (4)

where A is alkylene or phenylene; B is alkylene, phenylene, alkylene ether, phenylene ether, alkylene-phenylene ether, alkoxy-phenylene ether or alkyl-phenylene ether;, preferably B is —O—C₆H₄—O—(CH₂)₁₂—O—C₆H₄—O—; 40≧x≧20.

Preferably, said transition temperature is above a melting or glass transition temperature of polymer (3).

Preferably, A is (CH₂)₄; B is a substantially straight chain hydrocarbon preferably (CH₂)ₘ where 30≧m≧5, more preferably m is 12, 16 or 18.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 Illustrates schematically an organised, de-blended electrolyte complex;

FIG. 2 illustrates schematically an ion conducting channel within the electrolyte complex;

FIG. 3 illustrates schematically the electrolyte complex arranged as a lamellar texture;

FIG. 4 illustrates schematically an ion conducting channel for an electrolyte complex;

FIG. 5 shows a log conductivity vs 1/T plot for an electrolyte system according to a specific implementation of the present invention;

FIG. 6 shows a log conductivity vs 1/T plot for an electrolyte system according to a specific implementation of the present invention;

FIG. 7 shows a log conductivity vs 1/T plot for an electrolyte system according to a specific implementation of the present invention;

FIG. 8 shows a log conductivity vs 1/T plot for an electrolyte system according to a specific implementation of the present invention;

### DETAILED DESCRIPTION OF A SPECIFIC MODE FOR CARRYING OUT THE INVENTION

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

According to specific implementations of the present invention, there is provided two classes of complexes configured for enhanced ion conductivity, the first kind of system involves a main-chain ion conducting polymer configured with at least one hydrocarbon side-chain, the hydrocarbon side-chain being configured to interdigitate with side-chains of neighbouring ion conducting main-chain polymers.

According to the second system the ion conducting polymer main-chain is devoid of any significant hydrocarbon side-chains, such a system being configured to form an ordered conducting morphology due to association of main-chain sub-repeating units, for example, such sub-repeating units being ionophilic and ionophobic.

Accordingly, within this specification the ion conducting polymer, in the case of the first system is represented by PO1-sc in the case of the ion conducting polymer having a single alkylene oxide repeating unit in addition to a hydrocarbon side-chain and PO5-sc signifying an ion conducting polymer having five alkylene oxide repeating units and the hydrocarbon side-chain. This nomenclature does in no way restrict the present invention to utilisation of an ion conducting polymer comprising specifically one or five alkylene oxide repeating units within the main-chain and as will be appreciated by those skilled in the art the spirit of the present invention encompasses any number of alkylene oxide repeating units forming part of the main-chain.

In accordance with the second system, within this specification the ion conducting polymer is represented by P-nsc indicating a main-chain alkylene polyether having no or minimal side-chain, in contrast to the first class of system. Such nomenclature is used to distinguish the ion conducting polymer of the first system from that of the second system, accordingly the ion conducting polymer of the second system is not limited to alkylene polyethers comprising no side-chains as will be appreciated by those skilled in the art.

Additionally, within this specification the first ionic bridge polymer is represented by 1BP and the second ionic bridge polymer is represented by 2BP. The ionic bridge polymers (first or second) are usable and interchangeable with both the first and second electrolyte systems.

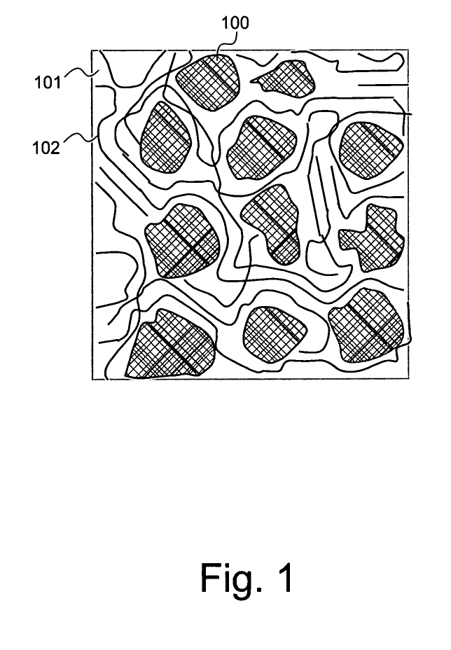

Referring to FIG. 1 herein there is illustrated a schematic view of the first or second electrolyte system comprising an ion conducting polymer 100; first ionic bridge polymer 101 and second ionic bridge polymer 102 exhibiting a de-blended morphology.

Following a de-blending process, described below, the electrolyte system adopts a well-defined morphology consisting of de-blended ion conducting polymer (PO1-sc, PO5-sc, P-nsc) 100 being interdispersed within a binding “glue”-like polymer functioning as an ionic bridge (1BP, 2BP) 101, 102, respectively. Accordingly, a polymer electrolyte system is provided allowing ion transport, and in particular metal ion transport, between electrodes of a battery/galvanic cell. According to specific aspects of the present invention ion transport within regions 100 occurs via ionophilic repeating units, in particular ionophilic channels, bridging polymers 1BP and/or 2BP functioning to allow cation transport between the PO1-sc, PO5-sc or P-nsc lattice.

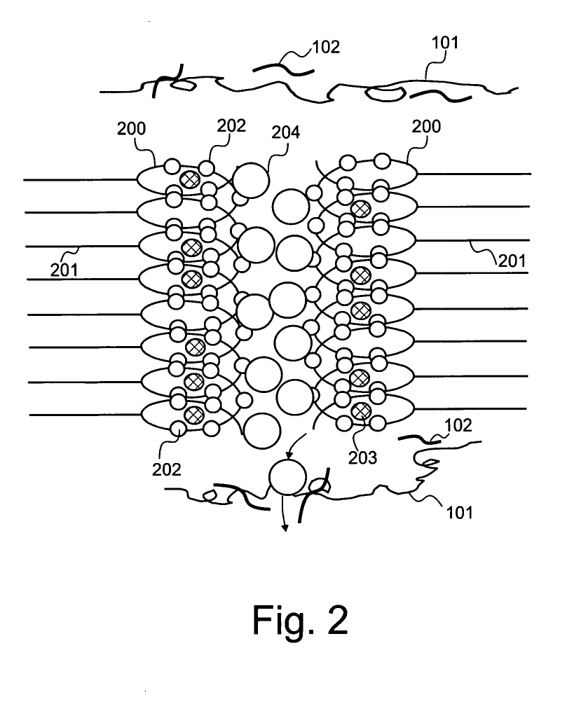

Referring to FIG. 2 herein there is illustrated a schematic view of the first electrolyte system as detailed with reference to FIG. 1 herein comprising PO1-sc, PO5-sc repeating units having main-chain ionophilic repeating units 200; ionophobic side-chain repeating units 201; coordinating sites 202; metal ions 203 and complex anions 204.

According to specific implementations of the present invention following the de-blending process the electrolyte system adopts a well-defined morphology being arranged into ionophobic repeating unit regions 201 and ionophilic repeating unit regions or channels 200. In such a configuration ion transport 203 is provided via the main-chain ion conducting polymer backbone within the lamellar or micellar regions of PO1-sc and/or PO5-sc. As detailed with reference to FIG. 2 herein ion transport between PO1-sc and/or PO5-sc regions is provided by 1BP and/or 2BP 101, 102 as indicated by displacement arrow 205. Accordingly an ionic bridge medium is provided between lamellar layers or micellar regions. Particularly, the utilisation of 1BP and 2BP provides for sustained reduced temperature dependent conductivity characteristics within both the first and second electrolyte systems. Due to the relative emotional freedom enjoyed by 1BP and 2BP within the first and second systems, on cooling the electrolyte an otherwise observed decrease in ion conductivity due to shrinkage and/or a freezing of regions 100 is offset by the “glue”-like properties of the interdispersed 1BP and 2BP.

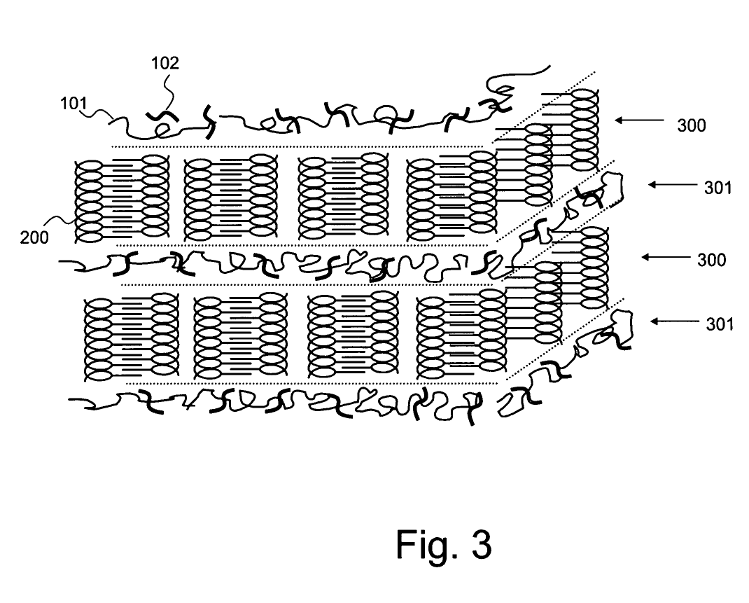

Referring to FIG. 3 herein there is illustrated a schematic view of the first electrolyte system as detailed with reference to FIG. 2 herein comprising a ion conducting polymer layers 300; and inter-lamellar ionic bridge layers 301.

As illustrated in FIG. 3 herein the ionophobic repeating unit side-chains interdigitate so as to form an ordered lamellar morphology wherein ion transport is provided via the ionophilic repeating unit channels 200. Whilst incorporation of 2BP increases the observed cation conductivity, 2BP also serves to maintain substantially ion conductivity on passing through the melting and/or glass transition temperature of the interdigitated side-chains.

Enhanced conductivity is also realised by adaptation of the polyether main-chain ion conducting polymer so as to create an “interruption” within the substantially helical ion conducting channels. According to specific aspects of the present invention involving the first electrolyte system, ion conducting site voids are created in the ion transport channels involving a copolymer of PO1-sc and PO5-sc, a reduced number of coordinating oxygens being available in PO1-sc than PO5-sc. Such coordinating site deficiencies within the conducting channel facilitate ion mobility due to the creation of vacancies into which the metal cations can move to and from. An ion jump-type motion may be envisaged.

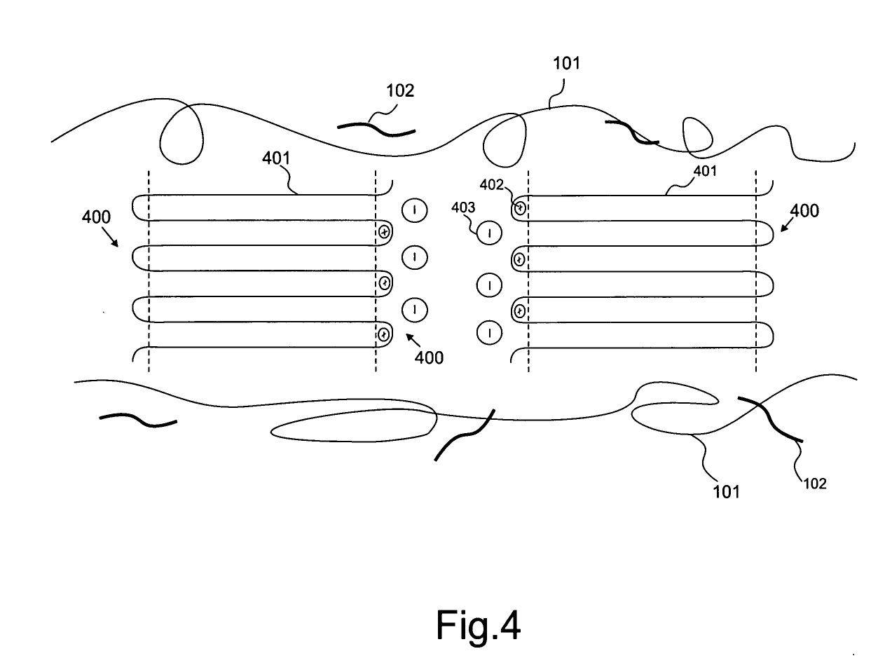

Referring to FIG. 4 herein there is illustrated a schematic view of the second electrolyte system comprising an ion conducting polymer having ionophilic repeating units 400; ionophobic repeating unit regions 401; metal cations 402; complex anions 403 and ionic bridge polymers 101, 102 as described herein before with reference to FIGS. 1 to 3 herein.

According to the second electrolyte system a self organising ion conducting electrolyte is formed comprising constrained polyether loops 400 disposed at alternate sides of ionophobic hydrocarbon units 401 to form a lamellar morphology being similar to that described with reference to FIGS. 1 to 3 herein. Accordingly, the second electrolyte system exhibits similar dielectric environmental properties when compared with the first electrolyte system. Effectively, metal ions 402 are transported within ionophilic repeating unit channels within the lamellar structure. Due to the de-blended order of P-nsc, resulting from the ionophilic/ionophobic repeating unit association, the polyether folds 400 are prevented from coordinating strongly with the metal ions; such strong coordination serving to inhibit metal ion transport across the electrolyte. An ordered electrolyte lattice of amphiphilic repeating units is therefore provided being configured for enhanced ion transference.

As detailed in FIG. 4 herein 1BP and/or 2BP may also be incorporated within the P-nsc electrolyte complex so as to form an amorphous binding/ionic bridge medium allowing ion transport between lamellar or micellar regions.

According to specific implementations of the present invention the following solvent-free polymer based electrolyte systems exhibit substantial de-coupled ionic mobility at ambient (25° C.) temperatures. Additional reduced temperature dependent conductivity characteristics are also observed:

First Electrolyte System

PO1-sc+1BP (and/or)+2BP;

PO5-sc+1BP (and/or)+2BP;

PO1-sc: PO5-sc+1BP (and/or)+2BP;

Second Electrolyte System

P-nsc;

P-nsc+1BP (and/or)+2BP.

According to either electrolyte system, and as detailed above, 1BP provides an ionic bridge between lamellar or micellar domains whilst 2BP acts as a “surfactant” being interdisposed between 1BP and PO1-sc, PO5-sc and/or P-nsc. 2BP optionally being a shorter tri-block polymer may be considered more maneuverable than the larger polymer 1BP such that 2BP is found to assist in the de-blending process to form the ordered lamellar/micellar textures.

There will now be described specific examples according to certain aspects of the present invention.

PO1-sc may be represented by specific formula (I):

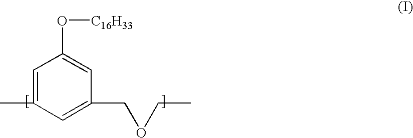

PO5-sc may be represented by specific formula (II):

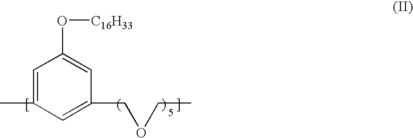

P-nsc may be represented by specific formula (III): [symbol]
O—(CH₂)₁₂—(O—CH₂—CH₂)₄—O [symbol] (III)

1BP may be represented by specific formula (IV):

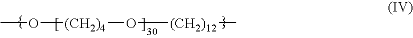

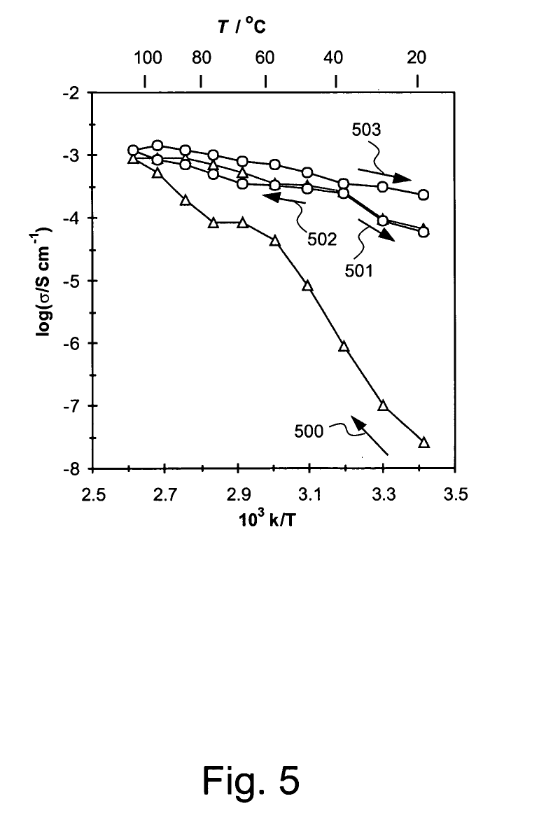

2BP may be represented by specific formula (V): 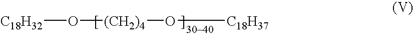
Referring to FIG. 5 herein there is illustrated AC conductivities measured by complex impedance spectroscopy as a log v vs 1/T plot for the first electrolyte system comprising the ion conducting polymer formed as a copolymer of compound (I) and (II): compound (IV): LiBF₄ in molar rations (1:1:1.2). During an initial heating (de-blending process) up to ca. 100° C. the conductivity rose steeply. On cooling 501 the conductivity remained high down to ambient temperature. Following a second heating cycle 502 and cooling cycle 503 the conductivities remained high exhibiting reduced temperature dependence of the first heating cycle. Accordingly, following initial heating cycle 500 the lamellar and/or micellar structure as detailed with reference to FIG. 3 herein is accountable for the reduced temperature-dependence of the de-blended electrolyte system. Accordingly conductivities of the order 10⁻⁴-10⁻³ S cm⁻¹ were observed with this system.

As detailed above, enhanced ion conductivity is provided along the ionophilic main-chain polymer due to the interdispersion of compound (I) within compound (II) forming the ion conducting copolymer. Interdigitation of the C₁₆H₃₃ hydrocarbon side-chains provides a well defined electrolyte morphology such that the ionophilic oligoethylene oxide repeating units organise to form substantially helical ion conducting channels.

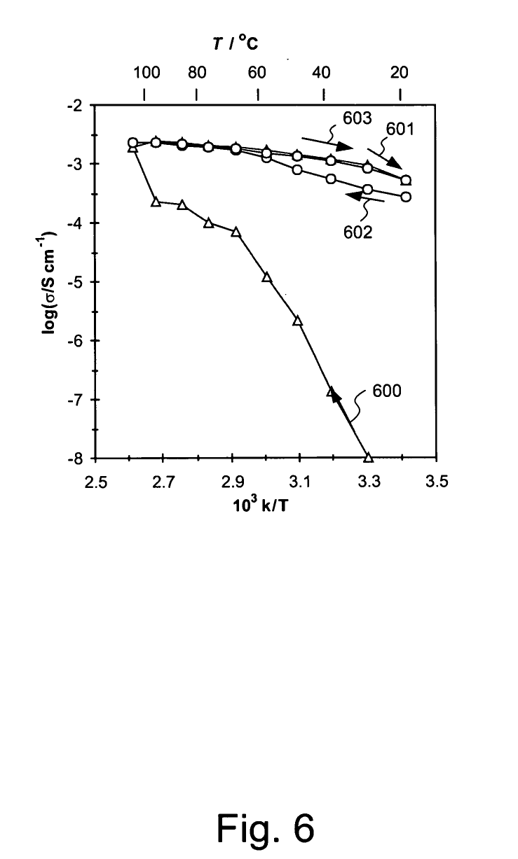

Referring to FIG. 6 herein there is illustrated AC conductivities measured by complex impedance spectroscopy as a log σ vs 1/T plot, for the first electrolyte system comprising compound (I)-compound (II) copolymer: compound (IV): compound (V): LiBF₄ in the molar ratios (1:0.8:0.2:1.2).

As observed with the first electrolyte system detailed with reference to FIG. 5 herein following a first initial heating 600 consistently high conductivities are maintained following a first cooling cycle 601, and during and in response to a second heating cycle 602 and subsequent cooling cycle 603. Due to the incorporation of the “surfactant” compound (V), elevated AC conductivities were observed for this system as compared with the system of FIG. 5 herein.

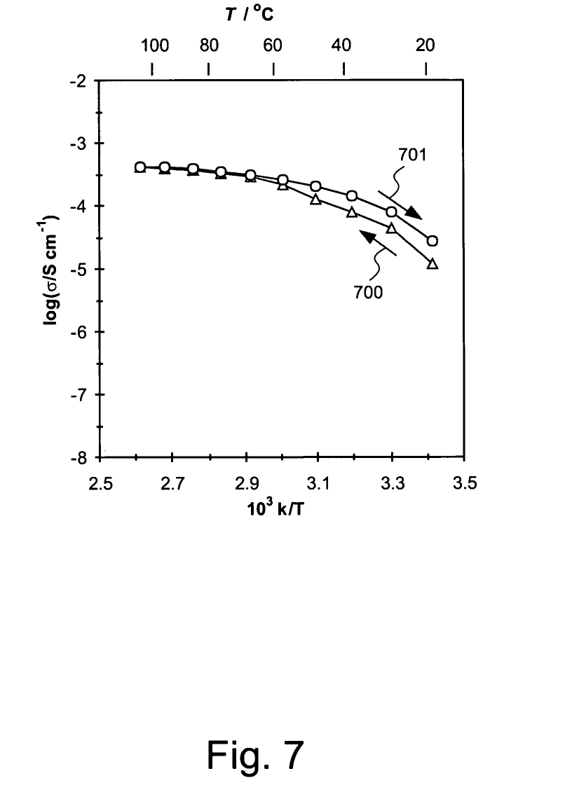

Referring to FIG. 7 herein there is illustrated AC conductivities measured by complex impedance spectroscopy as a log σ vs 1/T plot for the second electrolyte system comprising compound (III): LiClO₄ in molar ratio (2:1).

Following a first heating run 700 structural order is established as detailed with reference to FIG. 4 herein where the ionophilic polymer repeating units organise to form ion conducting channels comprising tetraethylene oxide constrained loop coordinating sites. Similarly, the ionophobic hydrocarbon units—(CH₂)₁₂— 401 stack alongside one another being separated by ca. 4 to 5 Å being similar in magnitude to the separation between the C₁₆H₃₃ hydrocarbon side-chain unit separations of compound (I) and (II) when organised into lamellar textures.

The highly ordered second electrolyte system as detailed with reference to FIG. 7 herein exhibits low temperature dependence providing AC conductivities of the order 10⁻⁴-10⁻³ S cm⁻¹. The second electrolyte system, even without an ionic bridge copolymer, is configured to allow ion conductivities of such orders of magnitude at or in close proximity to ambient temperature (25° C.).

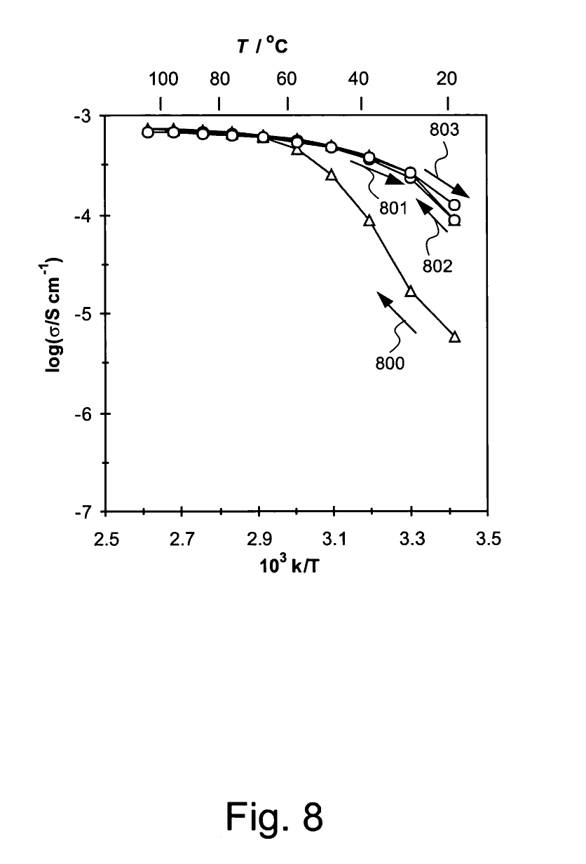

Referring to FIG. 8 herein there is illustrated AC conductivities measured by complex impedance spectroscopy as a log σ vs 1/T plot for the second electrolyte system compound (III): compound (IV): compound (V): LiBF₄ at molar ratios (1:0.8:0.2:1.2).

Being similar to the second electrolyte system as described with reference to FIG. 7 herein the addition of compound (V) has the effect of raising the AC conductivities in addition to reducing the temperature dependent conductivity effect.

As with FIG. 7 herein, following an initial heating 800 corresponding to a de-blending of the amorphous electrolyte, the organised structure of FIG. 4 herein is established prior to and during first cooling cycle 803, the morphology being consistently maintained throughout second heating and cooling cycles 802, 803, respectively.

DC polarisation measurements using lithium electrodes gave ambient conductivities in the range 10⁻³ to 10⁻² S cm⁻¹ in good accord with AC impedance measurements. Such DC conductivities thereby implying Li⁺ transport between electrodes. Moreover, conductivities of the order 10⁻² S cm⁻¹ were observed at ambient temperature; such conductivities being established and maintained following an initial “electrolyte-ordering”.

There will now be described specific preparation and examples to illustrate specific aspects of the present invention.

General Preparation Procedure for Compound (I), (II) and (I-II) Copolymer

### EXAMPLE 1

Polymers were prepared in 20-50% solution in mixtures of dry dimethylsulphoxide (DMSO): tetrahydrofuran (THF) co-solvent. By varying the proportions of DMSO to THF the copolymer of compound (I) and (II) may be prepared with varying amounts of compound (I) repeating units being interdispersed amongst the repeating units of compound (II). In particular, increasing the amount of DMSO (being a substantially polar solvent) has the effect of increasing aggregation of the hydrocarbon side-chains promoting synthesis of compound (I) repeating units over those of compound (II) within the compound (I)-(II) copolymer.

General Preparation Procedure for (I), (II) and (I-II) Copolymer

### EXAMPLE 2

Copolymers of compound (I) and compound (II) mixed polyether skeletal sequences were obtained from reactions involving appropriate molar proportions of the three types of monomer 5-alkyloxy-1,3-bis(bromomethyl)benzene, 5-alkyloxybenzene-1,3-dimethanol and tetraethylene glycol. For copolymers with greater proportions of compound (I) units a proportion of tetraethylene glycol was replaced by the alkyloxybenzene-1,3-dimethanol. However, the relative monomer proportions were determined by solubility considerations rather than stoichiometry owing to the amphiphilic nature of the side chain bearing monomers and the polymer product. The reaction also involved dehydration condensation between benzylic hydroxyls as well as the Williamson type condensations between hydroxyls and halogen functionalities.

Copolymers with mixed alkyl side chains were readily prepared by mixing the appropriate side chain bearing monomers in the desired molar proportion. In this case the molar proportions in the monomer mixture are apparently reproduced in the polymer product in which they are presumably in random sequence.
Synthesis of 5-hydroxybenzene-1,3-dicarboxylic acid diethyl ester

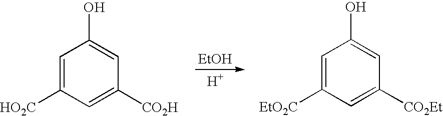

36.5 g (0.2 mol) 5-hydroxyisophthalic acid, 150 ml ethanol and 2 ml concentrated sulphuric acid were refluxed for 3 hrs. The ethanol was removed under vacuum and the white crystals were washed with water and then dissolved in 200 ml ethyl acetate. The solution was washed sequentially with aqueous sodium bicarbonate solution and water and finally dried over magnesium sulphate. After concentrating the solution under vacuum, white needles separated. The yield of 5-hydroxybenzene-1,3-dicarboxylic acid diethyl ester, m.p. 106° C., was 43.4 g (91%). IR: 3291.4, 2985, 2907, 1804-1700, 1400-1250 cm⁻¹.
Synthesis of 5-hexadecyloxybenzene-1,3-dicarboxylic acid diethyl ester

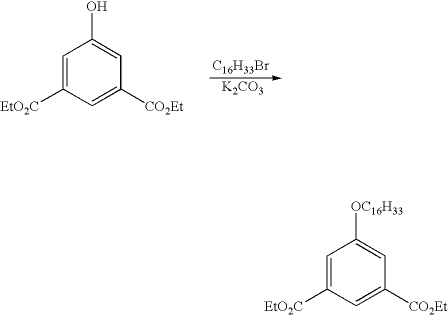

16.5 g (0.069 mol) 5-hydroxybenzene-1,3-dicarboxylic acid diethyl ester, 21 g (0.069 mol) 1-bromohexadecane and 120 ml acetone were refluxed in the presence of 11.9 g (0.086 mol) potassium carbonate for 24 hrs. After addition of 100ml water, the solution was extracted with pentane. The pentane solution was washed with aqueous potassium hydroxide solution, water and then dried over magnesium sulphate. The solvent was evaporated under reduced pressure. The yield of 5-hexadecyloxybenzene-1,3-dicarboxylic acid diethyl ester, m.p. 45° C., was 24 g (75%). IR: 3042, 2935, 1724, 1608, 1501, 1475 and 1251 cm⁻¹.
Synthesis of 5-hexadecyloxybenzene-1,3-dimethanol

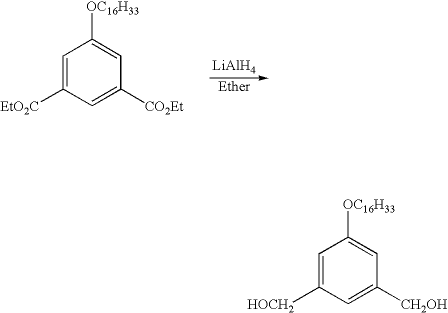

15 g (0.0325 mol) 5-hexadecyloxybenzene-1,3-dicarboxylic acid diethyl ester was reduced using 3.1 g (0.082 mol) lithium aluminum hydride by refluxing in ethyl ether for 4 hrs. Ethyl acetate was added into the solution to decompose the remaining lithium aluminium hydride. The solution was poured into cooled 20% sulphuric acid. The mixture was extracted with chloroform. After drying over magnesium sulphate, the extract was evaporated under reduced pressure. The crude product was recrystallized from dichloromethane to afford white crystals. The yield of 5-hexadecyloxy benzene-1,3-dimethanol, m.p. 90° C., was 10 g (81%). IR: 3256, 3060, 2917, 1600, 1472, 1150 and 1031 cm⁻¹. Elemental analysis, required: (%) C (76.19), H(11.11); found: (%) C (76.07), H (11.40). ¹H NMR(CDCl₃) δ 0.85 (t, 3H), 1.25 (s 24H), 1.45 (5 peaks, 2H), 1.75 (5 peaks, 2H), 3.9 (t 2H), 4.65 ( d, 4H), 6.85 (s, 2H), 6.95 (s,1H).
Synthesis of 5-hexadecyloxy-1,3-bis(bromomethyl)benzene

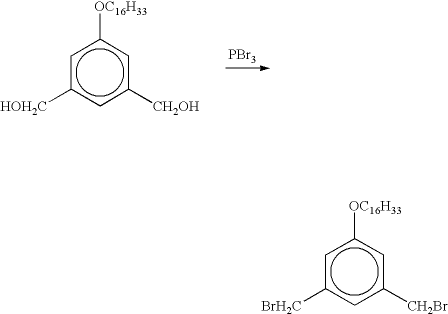

5 g of 5-hexadecyloxybenzene-1,3-dimethanol was suspended in 20 mL dry ethyl ether and stirred under a dry atmosphere and cooled down to 0° C. Into the suspension, 3.18 g of phosphorous tribromide was added dropwise, while keeping the temperature of the mixture below 5° C. After completion of the addition, the solution was allowed to warm up to room temperature and stirred for 10 hrs. The reaction mixture was then poured into a crushed ice bath, the separated organic layer was washed with a 10% sodium carbonate in water solution. The product was dried over anhydrous potassium carbonate and the solvents evaporated to yield white crystals. ¹H NMR(CDCl₃) δ 0.85 (t, 3H), 1.25 (s, 28H), 1.45 (5 peaks, 2H), 1.75 (5 peaks, 2H), 3.95 (t, 2H), 4.40 (s, 4H), 6.85 (s, 2H). 6.95 (s, 1H). Elemental analysis: Br, required 31.68%, found 31.49%.
Synthesis of compound (II)

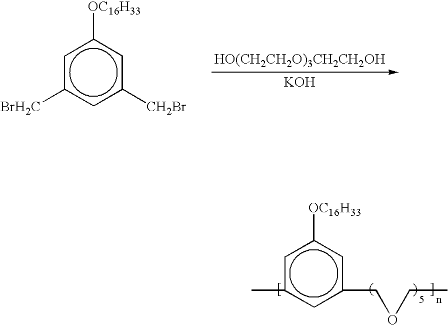

Compound (II), was prepared by heating with gentle stirring at 3-50° C. of 1 g (0.002 mol) 5-hexadecyloxy-1,3-bis(bromomethyl)benzene, 0.385 g (0.002 mol) tetraethylene glycol, and 0.44 g (0.008 mol) potassium hydroxide in 1 ml dimethyl sulphoxide and 1 ml THF for 3 hours. The polymer was precipitated in water. The mixture was neutralized with concentrated acetic acid. The polymer was separated and washed with hot water 3 times to remove inorganic salt and finally with hot methanol 3 times to remove monomer. ¹H NMR(CDCl₃) δ 0.85 (t, 3H), 1.25 (s, 28H), 1.75 (5 peaks, 2H), 3.65 (d, 15H), 3.95 (t, 2H), 4.50 (s, 4H), 6.80 (d, 3H). Hot stage microscopy indicates that the polymer melts at 27° C. The FTIR spectrum shows that the peak of OH group (3256 cm⁻¹) is not present.

Synthesis of compound (I)

### EXAMPLE 1

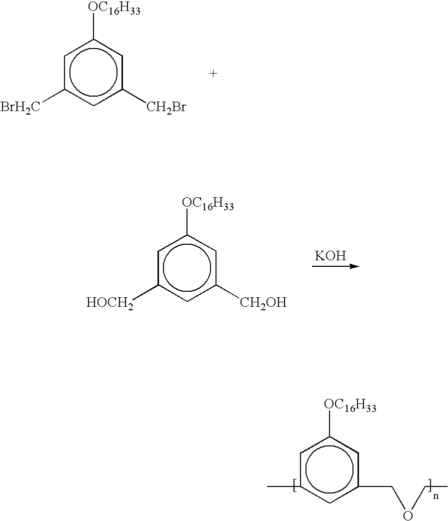

Compound (I), was prepared by heating with gentle stirring at 60° C. of 1 g (0.002 mol) 5-hexadecyloxy-1,3-bis(bromomethyl)benzene, 0.75 g (0.002 mol) 5-hexadecyloxybenzene-1,3-dimethanol, and 0.44 g (0.008 mol) potassium hydroxide in 1ml dimethyl sulphoxide and 1 ml THF for 3 days. The polymer was precipitated in water. The mixture was neutralized with concentrated acetic acid. The polymer was separated and washed with hot water 3 times to remove inorganic salt and finally with hot methanol 3 times to remove monomer. ¹H NMR(CDCl₃) δ 0.85 (t, 3H), 1.25 (s, 27H), 1.45 (5 peaks, 2H), 1.75 (5 peaks, 2H), 3.95 (t, 2H), 4.50 (s, 4H), 6.85 (d, 3H). Tₘ=42° C. (hot stage optical microscopy). The FTIR spectrum shows that the OH peak (3256 cm^{31 1}) is not present.

Synthesis of Compound (I)-(II) Copolymer

### SPECIFIC EXAMPLE 1

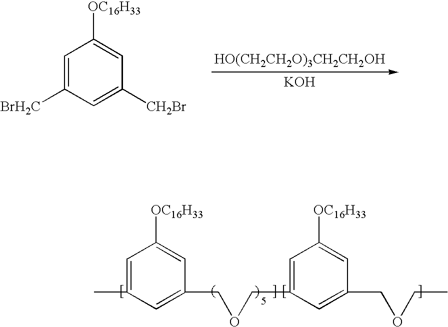

The copolymer of compound (I)-(II), was prepared by heating with gentle stirring at 60° C. of 1 g (0.002 mol) 5-hexadecyloxy-1,3-bis(bromomethyl)benzene, 0.385 g (0.002 mol) tetraethylene glycol, and 0.88 g (0.016 mol) potassium hydroxide in 2 ml dimethyl sulphoxide for 20 min. The polymer was precipitated in water. The mixture was neutralized with concentrated acetic acid. The polymer was separated and washed with hot water 3 times to remove inorganic salt and finally with hot methanol 3 times to remove monomer. ¹H NMR(CDCl₃) δ 0.85 (t, 3H), 1.25 (s, 28H), 1.45 (5 peaks, 2H), 1.75 (5 peaks, 2H), 3.60 (2 main peaks, 10.6H), 3.95 (t, 1.6H), 4.50 (s, 3.3H), 6.80 (d, 2.7H). The GPC gave molar mass averages, M_{w}=70.5×10³, M_{z}=4.9×10⁶. Hot stage microscopy indicates that the polymer melts at 28° C. The FTIR spectrum shows that the peak of OH group (3256 cm⁻¹) is not present. The ratio [ethoxy hydrogens(δ 3.60)]/[aromatic hydrogens(δ 6.8)]=(3/2.7)×(10.6 /16)=0.74 indicates 26% of compound (I) units in the copolymer.

Synthesis of Copolymer of (I) and (II) Variant

### SPECIFIC EXAMPLE 2

In the following example both types of copolymerization-skeletal chain and side chain-were combined to give a copolymer of compound (I) and (II) having 50/50 molar mixture of —C₁₂H₂₅ and —C₁₈H₃₇ side chains and replacing the C₁₆H₃₃ side chains of compounds (I) and (II). The different repeating units were mixed to give a copolymer comprising 80 mol % of the compound (I) variant and 20 mol % of the compound (II) variant.

A mixture of 0.593 g (0.0011 mol) 5-octadecyloxy-1,3-bis(bromomethyl)benzene, 0.5 g (0.0011 mol) 5-dodecyloxy-1,3-bis(bromomethyl)benzene, 0.090 g (0.0011 mol) 5-octadecyloxybenzene-1,3-dimethanol, 0.113 g (0.0011 mol) 5-dodecyloxybenzene-1,3-dimethanol, 0.325 g (0.0017 mol) tetraethyleneglycol 0.30 g (0.0044 mol) of potassium hydroxide (15% hydrated) was dissolved and heated with stirring at 65° C. in dimethylsulphoxide for 24 hours. The temperature was then raised to 85° C. for a further 24 hours after which a further 0.30 g (0.0044 mol) of potassium hydroxide (15% hydrated) was added and the reaction continued for 5 days. The polymer was then precipitated in water and the mixture was neutralised with concentrated acetic acid. The polymer was separated and washed with hot water 3 times to remove inorganic salts and was finally washed several times with hot methanol to remove monomers. The polymer was then dried by warming under vacuum. ¹H NMR (CDCl₃) δ 0.85 (t, 3H); 1.25 and 1.45 (5 peaks and 5peaks, 24.4H); 1.75 (5 peaks, 2 H); 3.60 (2 peaks, 3.6H ethoxy); 3.95 (t, 2H); 4.50 (s, 4H); 6.85 (5 peaks, 3 H aromatic). The peak at 3.6 ppm suggests that C16O5 units are present in proportion 3.6×100/16=22 mol %. The side chain peaks 0.85, 1.25, 1.45, 1.75 and 3.95 amount to 31 hydrogens corresponding to an ‘average’ pentadecyl side chain which represents 50/50 mol % mixture of C18 and C12 side chains.

Alternatively, finally divided potassium hydroxide may be added in large excess (1000%).
Synthesis of *Compound (IV)

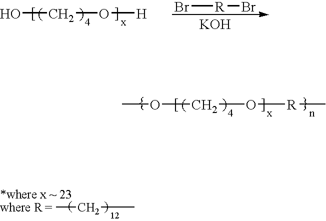

*Compound (IV) was prepared by standard Williamson condensation of hydroxy-terminated polytetrahydrofuran (Mₙ=1688 g mol⁻¹) with 1,12-dibromododecane and excess powdered KOH (8 molar ratio) at 90° C. *compound (IV) was purified by washing with dilute aqueous acetic acid followed by water and dried under vacuum. Gel permeation chromatography showed that <M_{w}>=2.5×10⁴. IR: 2940 cm⁻¹, 2859 cm⁻¹ (CH₂ stretch) and 1113 cm⁻¹ (C—O stretch). DSC of *compound (IV) indicates that the polymer melts at 24° C.
Synthesis of *Compound (V)

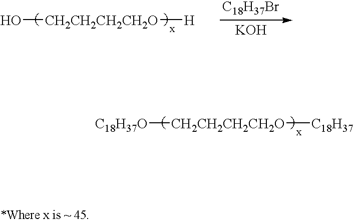

Compound (V) was prepared by standard Williamson condensation of 8.44 g (0.005 mol) hydroxy-terminated polytetrahydrofuran (Mₙ=1688 g mol⁻¹ ) with 3.33 g (0.005 mol) 1-bromododecane and excess powdered (8 molar ratio) 2.24 g KOH in 40 ml dimethyl sulphoxide for 7 days at 90° C. *Compound (V) was purified by washing with dilute aqueous acetic acid followed by water and dried under vacuum. The GPC result gave molar mass averages Mₙ=3250; M_{w}=4724. DSC of *compound (V) indicates that the polymer melts over the range 10-35° C. IR 3482 (νOH), shoulder 3000-2950 (ν—CH₃) 2923, 2798, 2740, (νCH₂)— 1110 (νC—O)

Synthesis of diethyl 2-octadecyl propandioate, synthesis of diethyl 2-octadecyl propanedioate

After dissolving 2.3 g of Na (0.1 mole) in 250 ml anhydrous EtOH, 16 g of diethylmalonate (0.1 mole ) was added dropwise under argon. After one hour at 50° C., 33.3 g (0.1 mole) of 1-bromooctadecane was added and the mixture stirred for 15 h. The solution was concentrated to dryness and washed with hot CHCl₃. The precipitate of NaBr is filtered and the solution dried over MgSO₄. After evaporation, a yellow oil was obtained and distilled to give, 23 g of diethyl 2-octadecyl propanedioate, yield 56%, bp: 185-190° C./0.04 torr. Mp: 28° C. IR: 2918 cm⁻¹ (CH₃ stretch), 2850 cm⁻¹ (CH₂ stretch) and 1733 cm⁻¹ (C═O stretch).

Ref: M. V. D. Nguyen, M. E. Brik, B. N. Ouvrard, J. Courtieu, L. Nicolas and A. Gaudemer, Bull. Soc. Chim. Belg., 1996, 105(14), 181-3.

Synthesis of 2-octadecyl propane-1,3-diol

23 g (0.056 mol) diethyl 2-octadecyl propanedioate was reduced using 5.4 g (0.14 mol) lithium aluminium hydride by refluxing in ethyl ether for 6 hrs. Ethyl acetate was added into the solution to decompose the extra lithium aluminium hydride. The solution was poured into cooled 20% sulphuric acid. Collect the white solid after ether was evaporated. Wash the solid with water, aqueous K₂CO₃ solution and then water. After drying in an oven, the product was extracted in dichloromethane using a soxhlet apparatus and evaporation of the solvent gave the pure white product. The yield of 2-octadecyl propane-1,3-diol, m.p. 88° C., was 15 g (81%).
Synthesis of Aliphatic Compound (II)

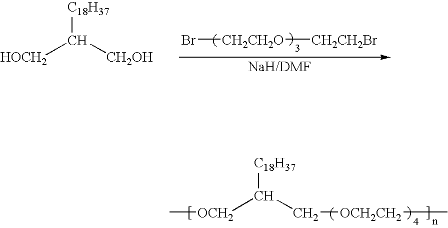

1.64 g (0.05 mol) 2-octadecyl propane-1,3-diol and 0.24 g (0.05 mol) NaH were mixed under an argon atmosphere, and 15 ml DMF was added. The mixture was heated slowly with stirring to 90° C. over 1 hour. 1.6 g of tetraethyleneglycol di-bromide in 5 ml DMF was added dropwise into the reaction and stirring was maintained at this temperature for 1 day. A second portion of 0.24 g NaH was then added and stirring continued at 90° C. for a further 3 days. After the reaction mixture was cooled, water was added, followed acetic acid to neutralize the solution. The solid was separated by filtration and twice washed with water. The solid was precipitated from methanol. The aliphatic compound (II), mostly melts at 45° C. ¹H NMR(400 MHz, CDCl₃): δ=0.86(t, 3H, CH₃), 1.22 (s, 34H, alkyl chain 17CH₂), 1.75 (m, 1H, CH), 3.60(t, 8H, OCH₂).

Synthesis of Compound (I)

### EXAMPLE 2

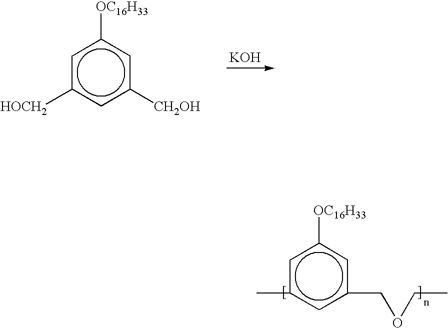

Compound (II), was prepared by heating with gentle stirring at 60° C. of 1.00 g (0.00264 mol) 5-hexadecyloxybenzene-1,3-dimethanol, and 2.24 g (0.04 mol) potassium hydroxide in 5 ml dimethyl sulphoxide for 7 days. The polymer was precipitated in water; the mixture was neutralized with concentrated acetic acid and extracted into chloroform. After evaporation of the chloroform, the residue was washed with hot water to remove inorganic salt and finally with hot methanol several times to remove the monomer. The GPC result gave molar mass averages M_{w}=10,000. DSC indicates that the polymer melts at 36° C. NMR (δ 4.5)shows only 2-3 α—hydrogens of the two —CH₂-attached to the benzene nucleus in the main chain. The FTIR spectrum shows that part of the peak of OH group disappears.
Synthesis of Compound (III)

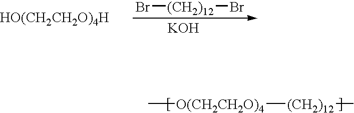

Compound (III) was prepared by standard Williamson condensation of tetra(ethylene glycol) with 1,12-dibromododecane and excess powdered KOH (8 molar ratio) at 90° C. The polymer was purified by washing with dilute aqueous acetic acid followed by water and dried under vacuum. The GPC result gave molar mass averages M_{w}=6884. DSC indicates that the polymer melts at 42° C.
Synthesis of compound (IV)-variant

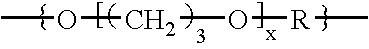

The above compound (IV)-variant may be prepared by a ring opening cationic polymerisation, such a process may similarly be employed for other similar compound (IV)-variants. The cyclic ether may be cleaved with BF₃ dietherate so as to generate the required polyalkylene oxide.

According to the compound (IV)-derivatives the R group is derived from a cyclic ether whereby copolymers may be synthesised involving cyclic ether ring opening polymerisations providing in turn high molecular weight polymers (M_{w} ca 10⁵). Where the compound (IV)-derivative comprises —(CH₂)₃— the cyclic ether derived R group may optionally comprise additional hydrocarbon side groups appended to the cyclic ether ring (for example methyl groups). Such side groups enhance the hydrophobic character of the polymer.

Specific examples of the compound (IV)-derivative copolymers comprise:
—[—(CH₂)₃—O—]−[—(CH₂)₄—O—]—; or

—[—(CH₂)₃—O—]−[—CH₂—C(CH₃)₂—CH₂—O—]—; where repeating units are randomly mixed. Moreover, the ionophobic character of the resulting polymer may be selectively adjusted by varying the relative amount of the cyclic ether containing at least one side group, during polymerisation of the above compound (IV)-derivatives.

Accordingly and owing to the large polymer molecular weight distributions, electrolyte systems may be provided with enhanced mechanical properties being advantageous in the manufacture of batteries.

Electrolyte Preparation

Complexes were prepared by mixing the ion conducting polymer with 1BP and/or 2BP together with appropriate molar proportion of Li salt, being selected from, for example, LiClO₄, LiBF₄, LiBF₄, LiCF₃SO₃, or Li(CF₃SO₂)N, in a mixed solvent of dichloromethane/acetone. After removal of solvent with simultaneous stirring complexes were dried under vacuum at 50° C.-60° C.

An alternative preparation of the electrolytes may involve the known process of freeze-drying polymer-salt solutions following which the highly expanded polymer is collapsed as a powder and gently sintered below the de-blending temperature (ca. below 50° C.).

Cell Preparation

The Li electrodes were prepared under an atmosphere of dry argon from Li pellets mounted in counter-sunk cavities (500 μm deep) in stainless steel strips. Cells having ITO electrodes were prepared using cellulose acetate spaces (100 μm). Complex impedance measurements and DC polarisations were performed using a Solartron (RTM) 1287A electrochemical interface in conjunction with a 1250 frequency response analyser.

Lithium cobalt oxides, manganese oxides or tin based alloys may also be utilised within the cell as cathodic electrodes being configured with a “binder” between particles and between electrode and electrolyte, the “binder” possibly being selected from any one or a combination of PEO, PO1-sc, PO5-sc, P-nsc, 1BP and/or 2BP.

1. A polymer based electrolyte complex being configured to provide ion transport, said complex comprising:
a plurality of ion conducting polymers, each polymer of said plurality of polymers comprising an amphiphilic repeating unit, said polymers being arranged as a lattice of ionophobic repeating unit regions and ionophilic repeating unit channels, said channels being configured to provide ion transport;
a first ionic bridge polymer positioned substantially between said lattice, said ionic bridge polymer being configured to allow ion transport between said ionophilic repeating unit channels of said lattice;
said complex further comprising and being characterised by:
a second ionic bridge polymer positioned substantially between said lattice, said second ionic bridge polymer being configured to allow ion transport between said ionophilic repeating unit channels of said lattice.

2. The electrolyte complex as claimed in claim 1 wherein each polymer of said plurality of ion conducting polymers is represented by general formula (1): 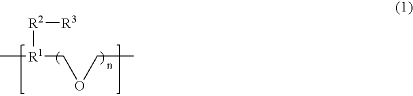
where R¹ is alkylene or a benzene nucleus; R² is oxygen, nitrogen, alkylene, phenylene or CH₂; R³ is alkyl, phenyl or alkyl-phenyl and 8≧n≧2, preferably n is 5.

3. The electrolyte complex as claimed in claim 2 wherein R³ is a substantially straight chain hydrocarbon preferably —(CH₂)ₘ—H where 30≧m≧5, more preferably m is 12, 16 or 18.

4. The electrolyte complex as claimed in claim 1 wherein each polymer of said plurality of ion conducting polymers is represented by general formula (2): 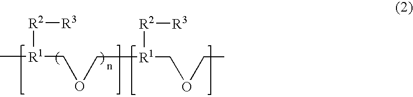
where R¹ is alkylene or a benzene nucleus; R² is oxygen, nitrogen, alkylene, phenylene or CH₂; R³ is alkyl or phenyl, a substantially straight chain hydrocarbon preferably —(CH₂)ₘ—H where 30≧m≧5, more preferably m is 12, 16 or 18 and 8≧n≧2 preferably n is 5.

5. The electrolyte complex as claimed in claim 3 wherein said electrolyte complex comprises a combination of said straight chain hydrocarbon where m is 12 and 18.

6. The electrolyte complex as claimed in claim 1 wherein each polymer of said plurality of ion conducting polymers is represented by the general formula (3): 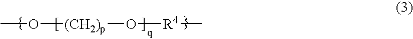
where R⁴ is alkylene or phenylene, a substantially straight chain hydrocarbon preferably (CH₂)ₘ where 3024 m≧5, more preferably m is 12, 16 or 18; 5≧p≧1, preferably p is 2; 6≧q≧2, preferably q is 4 or 5.

7. The electrolyte complex as claimed in claim 1 wherein said first ionic bridge polymer is represented by the general formula (4): [symbol]
O-(A-O-)ₓ-B [symbol] (4)
where A is alkylene or phenylene; B is alkylene, phenylene, alkylene ether, phenylene ether, alkylene-phenylene ether, alkoxy-phenylene ether or alkyl-phenylene ether; 40≧x≧20.

8. The electrolyte complex as claimed in claim 7 wherein A is (CH₂)₄; B is a substantially straight chain hydrocarbon preferably (CH₂)ₘ where 30≧m≧5, more preferably m is 12, 16 or 18, or B is —O—C₆H₄—O—(CH₂)₁₂—O—C₆H₄—O—.

9. The electrolyte complex as claimed in claim 1 wherein said second ionic bridge polymer is represented by the general formula (5): 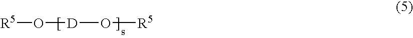
where D is alkylene or phenylene, preferably (CH₂)ᵣ, where 5≧r≧2, preferably r is 4; R⁵ is alkyl, phenyl, a straight chain or branched aliphatic hydrocarbon preferably C₁₈H₃₇; 40≧s≧20.

10. A polymer based electrolyte complex comprising:
an ion conducting polymer being represented by the general formula (1): 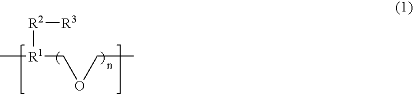
where R¹ is alkylene or a benzene nucleus; R² is oxygen, nitrogen, alkylene, phenylene or CH₂; R³ is alkyl, phenyl or alkyl-phenyl, a substantially straight chain hydrocarbon preferably —(CH₂)ₘ—H where 30≧m≧5, more preferably m is 12, 16 or 18 and 8≧n≧2, preferably n is 5;
a second ionic bridge polymer being represented by general formula (5): 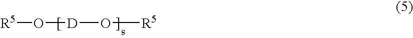
where D is alkylene or phenylene, preferably (CH₂)ᵣ, where 5≧r≧2, preferably r is 4; R⁵ is alkyl, phenyl, a straight chain or branched aliphatic hydrocarbon preferably C₁₈H₃₇; 40≧s≧20.

11. The electrolyte complex as claimed in claim 9 further comprising a first ionic bridge polymer being represented by general formula (4): [symbol]
O-(A-O-)ₓ-B [symbol] (4)
where A is alkylene or phenylene; B is alkylene, phenylene, alkylene ether, phenylene ether, alkylene-phenylene ether, alkoxy-phenylene ether or alkyl-phenylene ether; preferably B is —O—C₆H₄—O—(CH₂)₁₂—O—C₆H₄—O—; 40≧x≧20.

12. The electrolyte complex as claimed in claim 11 wherein R¹ is a benzene nucleus or CH; R² is oxygen; A is (CH₂)₄ and B is a substantially straight chain hydrocarbon preferably (CH₂)ₘ where 30≧m≧5, more preferably m is 12, 16 or 18.

13. The electrolyte complex as claimed in claim 12 wherein said electrolyte complex comprises a combination of said straight chain hydrocarbon where m is 12 and 18.

14. A polymer based electrolyte complex comprising:
an ion conducting copolymer being represented by the general formula (2): 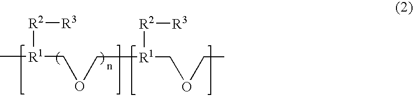
where R¹ is alkylene or a benzene nucleus; R² is oxygen, nitrogen, alkylene, phenylene or CH₂; R³ is alkyl or phenyl, a substantially straight chain hydrocarbon preferably —(CH₂)ₘ—H where 30≧m≧5, more preferably m is 12, 16 or 18 and 8≧n≧2 preferably n is 5; and
a second ionic bridge polymer being represented by general formula (5): 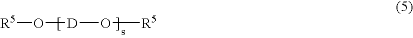
where D is alkylene or phenylene, preferably (CH₂)ᵣ, where 5≧r≧2, preferably r is 4; R⁵ is alkyl, phenyl, a straight chain or branched aliphatic hydrocarbon preferably C₁₈H₃₇; 40≧s≧20.

15. The electrolyte complex as claimed in claim 14 further comprising a first ionic bridge polymer being represented by general formula (4): [symbol]
O-(A-O-)ₓ-B [symbol] (4)
where A is alkylene or phenylene; B is alkylene, phenylene, alkylene ether, phenylene ether, alkylene-phenylene ether, alkoxy-phenylene ether or alkyl-phenylene ether, preferably B is —O—C₆H₄—O—(CH₂)₁₂—O—C₆H₄—O—; 40≧x≧20.

16. The electrolyte complex as claimed in claim 15 wherein A is (CH₂)₄; B is a substantially straight chain hydrocarbon preferably (CH₂)ₘ where 30≧m≧5, more preferably m is 12, 16 or 18.

17. A polymer electrolyte being configured to provide ion transport, said electrolyte comprising:
an ion conducting polymer comprising an amphiphilic repeating unit, said ion conducting polymer being represented by general formula (3): 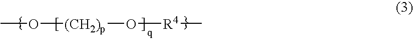
where R⁴ is alkylene or phenylene, a substantially straight chain hydrocarbon preferably (CH₂)ₘ where 30≧m≧5, more preferably m is 12, 16 or 18; 5≧p≧1, preferably p is 2; 6≧q≧2, preferably q is 4 or 5;
wherein said ion conducting polymer is arranged as a lattice of ionophobic repeating unit regions and ionophilic repeating unit regions, said ionophilic repeating unit regions being configured to provide ion transport.

18. The polymer electrolyte as claimed in claim 17 further comprising:
a first ionic bridge polymer being positioned substantially between said lattice of said ion conducting polymer, said first ionic bridge polymer being configured to allow ion transport between said ionophilic repeating unit regions of said lattice.

19. The polymer electrolyte as claimed in claim 18 wherein said first ionic bridge polymer is represented by the general formula (4): [symbol]
O-(A-O-)ₓ-B [symbol] (4)
where A is alkylene or phenylene; B is alkylene, phenylene, alkylene ether, phenylene ether, alkylene-phenylene ether, alkoxy-phenylene ether or alkyl-phenylene ether;, preferably B is —O—C₆H₄—O—(CH₂)₁₂—O—C₆H₄—O—; 40≧x≧20.

20. The polymer electrolyte as claimed in claim 19 further comprising:
a second ionic bridge polymer being positioned substantially between said lattice of said ion conducting polymer, said first ionic bridge polymer being configured to allow ion transport between said ionophilic repeating unit regions of said lattice.

21. The polymer electrolyte as claimed in claim 20 wherein said second ionic bridge polymer is represented by the general formula (5): 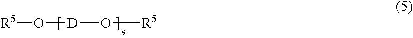
where D is alkylene or phenylene, preferably (CH₂)ᵣ, where 5≧r≧2, preferably r is 4; R⁵ is alkyl, phenyl, a straight chain or branched aliphatic hydrocarbon preferably C₁₈H₃₇; 40≧s≧20.

22. The polymer electrolyte as claimed in claim 19 wherein A is (CH₂)₄; B is a substantially straight chain hydrocarbon preferably (CH₂)ₘ where 30≧m≧5, more preferably m is 12, 16 or 18.

23. A polymer based electrolyte complex being configured to provide ion transport, said complex comprising:
an ion conducting polymer comprising an amphiphilic repeating unit, said ion conducting polymer being arranged as a lattice of ionophilic repeating unit regions and ionophobic repeating unit regions, said ionophilic repeating unit regions being configured to provide ion transport; and
an ionic bridge polymer being positioned substantially between said lattice, said ionic bridge polymer being configured to allow ion transport between said ion conducting polymers, said ionic bridge polymer being represented by general formula (5): 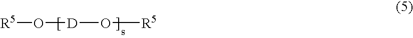
where D is alkylene or phenylene, preferably (CH₂)ᵣ, where 5≧r≧2, preferably r is 4; R⁵ is alkyl, phenyl, a straight chain or branched aliphatic hydrocarbon preferably C₁₈H₃₇; 40≧s≧20.

24. The electrolyte complex as claimed in claim 23 wherein said ion conducting polymer is represented by general formula (1): 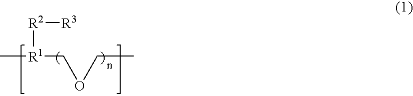
where R¹ is alkylene or a benzene nucleus; R² is oxygen, nitrogen, alkylene, phenylene or CH₂; R³ is alkyl, phenyl or alkyl-phenyl and 8≧n≧2, preferably n is 5.

25. The electrolyte complex as claimed in claim 23 wherein said ion conducting polymer is represented by general formula (2): 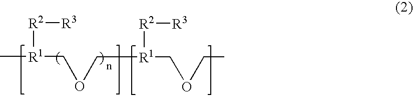
where R¹ is alkylene or a benzene nucleus; R² is oxygen, nitrogen, alkylene, phenylene or CH₂; R³ is alkyl or phenyl, a substantially straight chain hydrocarbon preferably —(CH₂)ₘ—H where 30≧m≧5, more preferably m is 12, 16 or 18 and 8≧n≧2 preferably n is 5.

26. The electrolyte complex as claimed in claim 23 wherein said ion conducting polymer is represented by general formula (3): 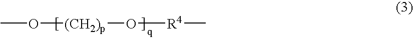
where R⁴ is alkylene or phenylene, a substantially straight chain hydrocarbon preferably (CH₂)ₘ where 30≧m≧5, more preferably m is 12, 16 or 18; 5≧p≧1, preferably p is 2; 6≧q≧2, preferably q is 4 or 5.

27. A galvanic cell comprising a polymer having a repeating unit according to claim 1.

28. The galvanic cell as claimed in claim 27 comprising a lithium salt being represented by general formula (6):
LiX (6)
where X is any one or a combination of ClO⁻, BF₄⁻, CF₃SO₃⁻ and/or (CF₃SO₂)N⁻.

29. A process for the preparation of a polymer being represented by general formula (3): 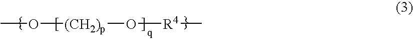
where R⁴ is alkylene or phenylene, a substantially straight chain hydrocarbon preferably (CH₂)ₘ where 30≧m≧5, more preferably m is 12, 16 or 18; 5≧p≧1, preferably p is 2; 6≧q≧2, preferably q is 4 or 5;
comprising the steps of:
(b) reacting a compound of general formula (7): 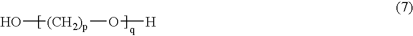
with Z—R⁴—Z, where Z is a halogen, preferably Br.

30. A process for the preparation of a polymer being represented by general formula (5): 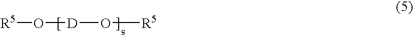
where D is alkylene or phenylene, preferably (CH₂)ᵣ, where 5≧r≧2, preferably r is 4; R⁵ is alkyl or phenyl, preferably C₁₈H₃₇; 40≧s≧20;
comprising the steps of:
(a) reacting a compound being represented by general formula (8): 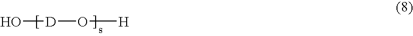
with R⁵—Z, where Z is a halogen, preferably Br.

31. A process for the preparation of a polymer based electrolyte complex comprising the steps of:
(a) forming an ion conducting polymeric material having repeating units being represented by general formula (1): 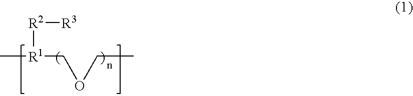
where R¹ is alkylene or a benzene nucleus; R² is oxygen, nitrogen, alkylene, phenylene or CH₂; R³ is alkyl, phenyl, a substantially straight chain hydrocarbon preferably —(CH₂)ₘ—H where 30≧m≧5, more preferably m is 12, 16 or 18 and 8≧n≧2, preferably n is 5;
(b) blending polymer (1) with a second ionic bridge polymer, said second ionic bridge polymer being represented by general formula (5): 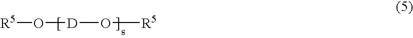
where D is alkylene or phenylene, preferably (CH₂)ᵣ, where 5≧r≧2, preferably r is 4; R⁵ is alkyl, phenyl, a straight chain or branched aliphatic hydrocarbon preferably C₁₈H₃₇; 40≧s≧20; and
(c) de-blending the polymeric blend of polymer (1) and (5) by heating said polymeric blend above a transition temperature.
